(19) United States
(12) Patent Application Publication
(10) Pub. No.: US 2018/0234505 A1
(43) Pub. Date: Aug. 16, 2018

(54) METHOD FOR INTERACTIVE SHARING OF APPLICATIONS AND DATA BETWEEN TOUCH-SCREEN COMPUTERS AND COMPUTER PROGRAM FOR IMPLEMENTING SAID METHOD

(71) Applicant: KINETI TECHNOLOGIES, Saint-Maurice-de-Santonnay (FR)

(72) Inventors: FABIAN Humbert, Saint-Maurice-de-Satonnay (FR); Guillamue Merrouche, Les Janroux, Julienas (FR)

(73) Assignee: Kineti Technologies, Saint-Maurice-de-Santonnay (FR)

(21) Appl. No.: 15/750,166

(22) PCT Filed: Aug. 3, 2016
(86) PCT No.: PCT/EP2016/068569

§ 371 Date: Feb. 2, 2018

(30) Foreign Application Priority Data
Aug. 4, 2015 (FR) 1557526

(51) Int. Cl. H04L 29/08; H04L 29/06; G06F 3/0488; G06F 3/14

(52) U.S. Cl. CPC H04L 67/141; H04L 67/42; G06F 3/1454; G06F 3/0488; H04L 67/1097

(57) ABSTRACT

A method for interactively sharing program and/or data among electronic devices including initiating a sharing session by a first electronic device; connecting a second electronic device to open sharing sessions; executing an application and/or data and/or interface for controlling a peripheral shared in open sharing sessions; making accessible the control of an application and/or data and/or interface in sharing sessions opened by each of the electronic devices; executing a display module of an application and/or data and/or control interface on each electronic device connected to sharing sessions; displaying on the screen of each electronic device connected to sharing sessions the applications and/or data and/or control interface.

### TECHNICAL AREA

The present invention relates to a method for interactive sharing of applications and/or data and/or peripherals between at least two touch-screen computers, such as a smartphone also called a pocket terminal, a tablet or a touch table for example, and a computer program for implementing the method. More particularly, the invention relates to a method for exchanging, viewing and manipulating in real time data between at least two peripherals by minimizing the bandwidth consumed and maximizing the quality of the data display on the peripherals. In addition, the invention also makes it possible to enter and/or modify data simultaneously by several people on the same peripheral and/or on a plurality of peripherals.

### PRIOR ART

In the field of computing and telecommunications, there are many computers with touch screens such as cell phones known as smartphones, tablets or touch tables, laptops that may be used daily in more and more ways, and, in particular, to identify and share information with other users.

This sharing of information has become essential in everyday life whether in the private sphere and/or in the professional world.

However, known sharing systems, although offering a number of interesting features, do not allow several objects to be manipulated simultaneously and in real time, while being displayed in real time on different remote electronic devices. In fact, prior art data sharing systems only allow users to act one after the other.

Furthermore, applications are also known for electronic teleconferencing or videoconferencing devices that allow screen sharing between two screens of at least two electronic devices. A first screen of a first electronic device is recorded in a video format and then it is retransmitted by streaming and displayed on the second screen of a second electronic device. However, this method is bandwidth consuming because the images are transmitted every 10 or 20 ms. Thus, this method requires strong compression of the video data which degrades the image quality. In addition, the stability of the exchanges is bad whenever the connection is not perfect, i.e. as soon as the bandwidth is low.

In order to overcome these drawbacks, application and/or data sharing methods have already been devised which make it possible to improve interactivity during the sharing of data. This is particularly the case with U.S. Pat. No. 8,965,349 and European Patent Application EP 2,869,188.

U.S. Pat. No. 8,965,349 discloses a method for sharing an application interactively comprising a step of initiating communication by a first electronic device with a second electronic device, wherein after the beginning of communication, transmission of a request from the first electronic device to share an application with a second electronic device; reception at the first electronic device of the sharing confirmation from the second electronic device; display on the first electronic device of the application and the data relating to the communication; generation of an instruction to the second electronic device by the first electronic device, wherein the instruction relates to the display of the application on the second electronic device; and transmission of the instruction to the second electronic device. The instruction is a screen image to be displayed on the second electronic device. The communication may be a video conference and, in this case, the data associated with the communication are images of the video conference. Thus, multiple devices may share applications or application data in such a way that the users of the electronic devices may each view the data of the application of another user, or interact with each other via a shared application.

Document EP 2 869 188 discloses an electronic device for sharing an application, and a method for controlling the electronic device. The server electronic device communicating with a client electronic device comprises a communication unit configured to form a connection with the client electronic device, a controller configured to determine an application to be shared with the client electronic device in order to generate shared data for the shared application, and to control the communication unit to transmit the shared data to the client electronic device, and a screen configured to display an execute screen of the shared application. The control method comprises a step of setting up a connection with the client electronic device, a step of determining an application to be shared with the client electronic device, a step of generating data of the shared application, wherein the information is intended to be shared, and a step of transmission of the shared data which is then displayed on the screen of the client electronic device.

However, these methods have the disadvantage of requiring a fairly large bandwidth so that, when the bandwidth is not wide enough, the data transfers degrade and it is not possible to interact between the different electronic devices in real time.

There is therefore a need for an efficient, simple, intuitive, stable solution for interactive sharing of all types of documents, files, objects, applications, software or application data, or software with multi-user interaction in real time and with real-time display feedback on all devices whether or not desired by the remote users.

### DISCLOSURE OF THE INVENTION

One of the aims of the invention is therefore to overcome these disadvantages by providing a method of interactive sharing of applications and data between touch-screen computers and computer programs for implementing the simple and inexpensive method while allowing interactive sharing of all types of documents, files, objects, applications, software or application data, or software, along with multi-user interaction in real time and real-time display feedback on all desired devices whatever the bandwidth of the communication between the various devices.

For this purpose and in accordance with the invention, a method provided for interactively sharing at least one program and/or at least one data item and/or at least one peripheral between at least two electronic devices comprises at least the following steps:
initiation of at least one so-called sharing session by at least one first electronic device,
connection of at least one second electronic device to the open sharing session(s),
execution of at least one application and/or at least one data item and/or at least one control interface of at least one shared peripheral in the open sharing session(s),
accessibility of the control of at least one application and/or at least one data item and/or at least one control interface of at least one shared peripheral in the one or more sharing session(s) opened by each of the electronic devices connected to the sharing session,
execution of a so-called display module of at least one application and/or at least one data item and/or at least one control interface of at least one shared peripheral on the device(s) connected to the sharing session(s),
display on the screen of the electronic device(s) connected to the sharing session(s) of the application(s) and/or the data and/or the control interface of at least one shared device by at least one of the electronic devices.

According to a first embodiment, the initiation of the sharing session comprises at least the following steps:
connection of a first electronic device to a server,
opening of a sharing session from the electronic device.

According to a second embodiment, the initiation of the sharing session comprises at least the following steps:
opening of a sharing session from a first electronic device,
connection of the first electronic device to a server.

Furthermore, the method according to the invention further comprises the following steps:
connection of a first electronic device to a server via an internet connection,
identification of the first electronic device as a client by the server,
connection of at least one second electronic device to the server,
identification in the sharing session of the one or more electronic devices by the server as a client,
transmission from one of the electronic devices connected to the sharing session of at least one command or at least one data item to at least one application and/or at least one data item and/or at least one control interface executed in the sharing session,
execution of the command and/or the data by the application and/or data and/or control interface executed in the sharing session,
transmission to the display module of the result of the execution of the command and/or the data by the application and/or data and/or control interface executed in the sharing session.

In addition, the method comprises a step of
generation by the server of at least one command to change the display screen of the one or more client electronic device(s) as a function of the variation of the data.
transmission of the command(s) to the client electronic device(s) to change the screen displayed.

Preferably, the method further comprises the following steps:
determination of the variation of the data relating to the screen displayed of a first electronic device between the instant t and the instant t−1,
transmission to the server of the variation of the data relating to the displayed screen of the first electronic device,

The server is located on at least one of the electronic devices.

Alternatively, the server may consist of a remote server connected to a communication network.

Advantageously, the server generates one or more commands for the one or more client electronic device(s) as a function of the bandwidth of the connection between the client electronic device(s) and the server.

Furthermore, the shared program and/or the data are compressed when the bandwidth of the connection between the first electronic device and the second electronic device(s) is less than or equal to a predetermined value.

During each connection of an electronic device to the sharing session, the method according to the invention preferably further comprises, a step of determining a privacy indicator in order to determine whether the application(s) and/or the data or the device(s) may be fully or partially shared or not.

In addition, during each connection of an electronic device to the sharing session, the method according to the invention further comprises a step of determining a sharing indicator in order to determine whether the other electronic device(s) connected to the sharing session is/are authorized to access the applications and/or data and/or peripherals of that electronic device.

Advantageously, the shared applications and/or the data are recorded on a remote server or a cloud.

Several users may advantageously manipulate the application(s) and/or the data and/or the peripheral(s) on the same electronic device.

Preferably, at least one electronic device comprises a touch screen.

Furthermore, the method according to the invention comprises a step of generating at least one command from an interaction between at least one user and the electronic device. The interaction may be performed by any means that are well known to persons skilled in the art such as pressure on a touch screen, movement in front of a Kinect system (registered trademark) or the like, movement of a mouse, input on a keyboard, etc. . . .

Pressing and/or moving with a finger on the touch screen of the device generates a request that is transmitted to the other electronic devices to display a pointer.

Furthermore, pressure and/or displacement with two fingers on the touch screen of the device generates a request transmitted to the other devices for moving and/or zooming and/or changing the application and/or data located under the fingers.

In addition, it comprises a step of generating at least one command from an object interacting with the electronic device.

For example, a pencil interacting with a touch screen of an electronic device generates an annotation in a window generated by the display module of the electronic device.

Advantageously, the history of each sharing session is recorded on a medium. By “history of each sharing session” is meant the history of the commands and/or elements displayed on the various electronic devices and/or connections/disconnections of the electronic devices to the sharing session, etc.

Furthermore, advantageously, the display, namely the dimensions and/or the orientation and/or the positioning on the screen of the one or more electronic devices connected to the sharing session(s), the application(s) and/or the data and/or peripheral(s) shared by at least one of the electronic devices is adapted as a function of the dimensions of the screen of the one or more electronic devices and/or technical characteristics of the electronic device(s).

In addition, as a function of the dimensions of the screen and/or the technical characteristics of the electronic device(s), the display on the screen of the electronic device(s) corresponds to an enlargement or a reduction of at least one determined display zone of another electronic device connected to the sharing session.

Another object of the invention relates to a computer program product for interactively sharing at least one program and/or at least one data item and/or at least one peripheral between at least two electronic devices, wherein the computer program product comprises a sequence of instructions for the implementation of a method according to the invention.

### BRIEF DESCRIPTION OF THE DRAWINGS

Other advantages and features will become more apparent from the following description of several alternative embodiments given as non-limiting examples of the method of interactive sharing of applications and data between touch-screen computers and computer programs for carrying out the method according to the invention, according to the attached drawing, wherein:

FIG. 1 shows a schematic representation in the form of a diagram of a touch-screen computer according to the invention,

FIG. 2 shows a schematic representation of a first application of the method according to the invention enabling at least two users to share data on a single touch-screen computer according to the invention,

FIG. 3 shows a schematic representation of a second application of the method according to the invention enabling at least one user of a first touch-screen computer according to the invention to share data with at least one another user of at least one second touch-screen computer according to the invention,

FIG. 4 shows a schematic flow diagram of the first step of the method according to the invention,

FIG. 5 shows a schematic flow chart of the second step of the method according to the invention,

FIG. 6 shows a schematic flow diagram of the third step of the method according to the invention,

FIG. 7 shows a schematic flow diagram of the fourth step of the method according to the invention,

FIG. 8 shows a schematic flow diagram of the fifth step of the method according to the invention,

FIG. 9 shows a schematic flow chart of the sixth step of the method according to the invention,

FIG. 10 shows a schematic flow diagram of a seventh step of the method according to the invention,

FIG. 11 shows a schematic flow diagram of a data compression step in the case of low bandwidth of the communication between the different touch-screen computers, using the method according to the invention,

FIG. 12 shows a flowchart of the steps for transmitting a message sent by a first client touch-screen computer to the other touch-screen computers with a client touch-screen according to the method of the invention,

FIG. 13 shows a flowchart of the steps for transmitting a pdf file between a first client touch-screen computer and other client touch-screen computers according to the method of the invention,

FIG. 14 shows a flowchart of the steps of transmission of a video between a first client touch-screen computer and other client touch screens according to the method according to the invention,

FIGS. 15A and 15B show schematic representations of the display screen of a first touch-screen computer and, respectively, a second touch-screen computer, at a time t, in accordance with the invention,

FIGS. 16A and 16B show schematic representations of the display screen of a first touch-screen computer and, respectively, a second touch-screen computer, at a time t+1 according to the invention,

FIGS. 17A and 17B show schematic representations of the display screen of a first touch-screen computer and, respectively, a second touch-screen computer, at a time t+2 according to the invention.

### EMBODIMENT OF THE INVENTION

A computer of the touch-screen tablet or table type comprising a file-sharing module according to the invention is described below; however, it is obvious that the computer may consist of any type of computer with or without a touch screen such as a smartphone or PC-type computer without departing from the scope of the invention.

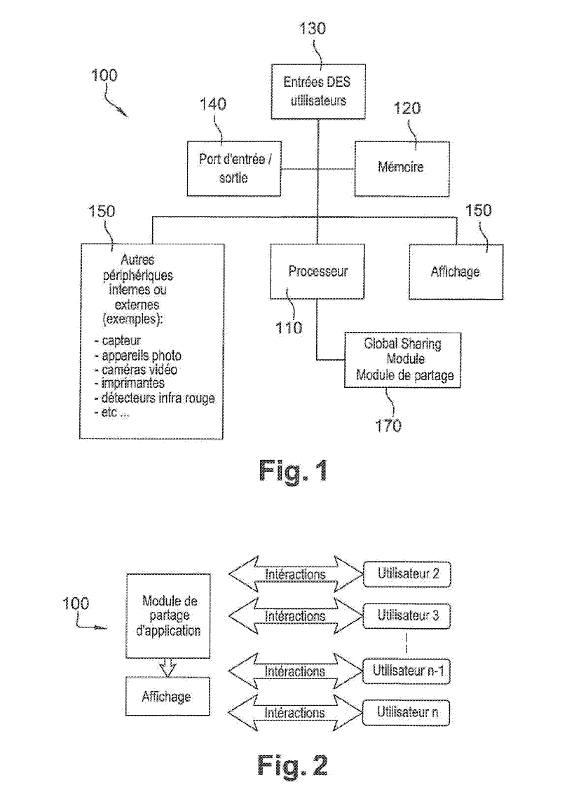

Referring to FIG. 1 which is a block diagram of an example of an electronic device 100 that may be used to interactively share applications and/or data and/or peripherals in accordance with the invention, the electronic device 100 may be a portable device, such as a smartphone, a touch table or tablet, a laptop, a digital camera, a digital telephone handset or the like, wherein the electronic device 100 comprises at least a Central Processing Unit (CPU) 110, which controls the various operations of the electronic device 100 and may interact with the other components of the device. The processor 110 may be any processor well known to persons skilled in the art such as a Pentium® or Atom® processor marketed by INTEL® or an A4 or A5 processor marketed by the Apple® company for example. The processor may consist of a single-core microprocessor or a multi-core microprocessor. A multi-core microprocessor is understood to mean a microprocessor having a plurality of physical cores which work in parallel, wherein each physical core comprises a set of circuits capable of executing programs in an autonomous manner along with all the functionalities necessary for the execution of a program, wherein these cores comprise: program counter, registers, calculation units, etc. Moreover, it will be noted that the electronic device 100 may comprise several processors even if only one is shown in FIG. 1. For example, a Graphics Processing Unit (GPU) may be used, wherein the graphics processor is well known per se as an integrated circuit that is generally present on a graphics card, a motherboard, or the CPU 110, and provides the display calculation functions.

It is obvious that the electronic device 100 may be a fixed device, such as a desktop computer, a PC, a digital telephone base, a television, a media center or the like without departing from the scope of the invention.

Furthermore, it will be observed that, in FIG. 1, the lines connecting the various elements of the electronic device represent communication paths between the elements, wherein these communication paths may be bidirectional or omnidirectional.

In addition to the microprocessor 110, the electronic device 100 comprises a memory 120, or other similar storage device, a user input module 130, an input/output port 140 enabling data transmission to and from the device 100, a display screen 150 and internal or external peripherals 160. The internal or external peripherals 160 comprise, for example, a camera to enable a user of the electronic device according to the invention to carry out a videoconference with a another person, such as a user of a second electronic device, a photo apparatus, a printer, an infrared detector or sensors. It should be noted that the user input module 130 generally allows a user to manipulate certain functions of the electronic device 100, including interacting and sharing resident applications on the storage of the apparatus and executed by the processor 110, and may consist of a device such as a touchpad, a keyboard, a mouse, a stylus or the like, wherein the peripheral may be connected to the electronic device via a wired or wireless connection (Wi-Fi or bluetooth, for example), or a touch screen, wherein the touch screen also forms the display screen 150. This touch screen may consist of a capacitive, resistive type screen, or may be based on interference with electromagnetic wavelengths, or any other type of touch screen well known to persons skilled in the art.

Furthermore, the electronic device according to the invention comprises software referred to as a sharing module 170 which makes it possible to control the aspects and interactions related to the interactive sharing of one or more applications and/or data and/or peripherals as detailed below. By “software” is meant a set of machine-interpretable instruction sequences and a data set necessary for these operations. Thus, the software comprises a computer program that is stored in the memory 120 and executed by the processor 110 whenever the applications are shared, or the sharing is initiated.

It goes without saying that the sharing module 170 may consist of firmware, hardware or software or a combination of these without departing from the scope of the invention. Furthermore, the sharing module 170 may be hosted, in whole or part, on a server or other remote device and may be accessible by other electronic devices engaged in sharing applications.

This sharing module 170 allows the interactive sharing of data, files, applications or software, or application and software data, on a single electronic device 100 between several users or between two or more electronic devices, local or remote.

These data, files, applications, software, or application and software data, may therefore be accessed by multiple users on multiple devices. Multiple users may even be, for example, on a single device such as a touch table, or a vertical interactive screen. In addition, some electronic devices need not have users as servers. Each user may then access data, files, applications or software, or application and software data that are made accessible. Each user of each electronic device may display, view, modify and manipulate different files, data, objects, applications or software in real time through shared software or application; this being alone or a multiple on each electronic device and performing all operations simultaneously with other users. Thus, the sharing module 170 allows all the users to interact on all the devices alone or as a multiple on each device simultaneously. The sharing will be possible according to the possible rights to be granted to each users to display, visualize, modify and manipulate various data, files, objects, applications or software or application or software data; or even, depending on the possible rights granted to the data, files, objects, applications or software, or application or software data.

All the actions of the users may be executed simultaneously with an almost immediate feedback display on the various electronic devices according to the invention.

In this way, multiple users may share information and collaborate without necessarily having to be physically present, as they may wish to congregate around a single device and interact with one another on a single electronic device simultaneously.

For example, a user may manipulate a drawing on a touch-interactive table in Paris, wherein the touch-interactive table forms a first electronic device according to the invention, while another person may take notes on the corner of the same table, while a third person draws on another corner of another touch table in New York, i.e. on a second electronic device according to the invention, while a fourth person may display in the center what his smartphone camera, i.e. a third electronic device according to the invention is shooting in Moscow, while others are viewing this on an interactive board in Tokyo, and may interact with each element. Thus, all the users may see the various graphic elements and interact with them.

For this purpose, all the electronic devices are able to communicate with each other by any mode (network, telephone communication, or other), wherein all the devices are equipped with electronic components and drivers for the dialogue of the electronic devices with each other or at least with the electronic device designated as the server.

An electronic device may act as the host of the interactive sharing solution software, while the other electronic devices may then only have to transmit their data or the actions of the users via this same sharing application that is also installed on the electronic device. The “server” application may then send the display information to the various electronic devices that wish to have the display feedback. The orientation of the various objects displayed may be interpreted by the electronic device on which it is displayed in order to adapt the orientation to the use.

The interaction and sharing module 170 also serves as a gateway for managing and organizing the user interface and all the electronic devices and functions of all the devices and peripherals of the internal or external devices. The mode of interaction of the user with the electronic device depends on each electronic device. All user-device interaction modes are possible.

During remote use, the solution according to the invention makes it possible to limit the bandwidth consumption by not permanently transmitting a video of the screen of a user unlike the methods of the prior art. According to the invention each electronic device has its own screen with its own graphic widgets that interact together. A widget is a software component. In addition, the rendering quality on the screen is also improved for items that will not be compressed.

With reference to FIG. 2, at least two or more users (n users) interactively share data, files, applications or software, or application and software data, on an electronic device 100 and may interact simultaneously with the different elements. This solution allows simultaneous active collaboration of each user on the electronic device 100. The advantage of this solution is to allow n users to collaborate, to interact together in real time simultaneously, and to share all kinds of data, files, applications or software, or application and software data.

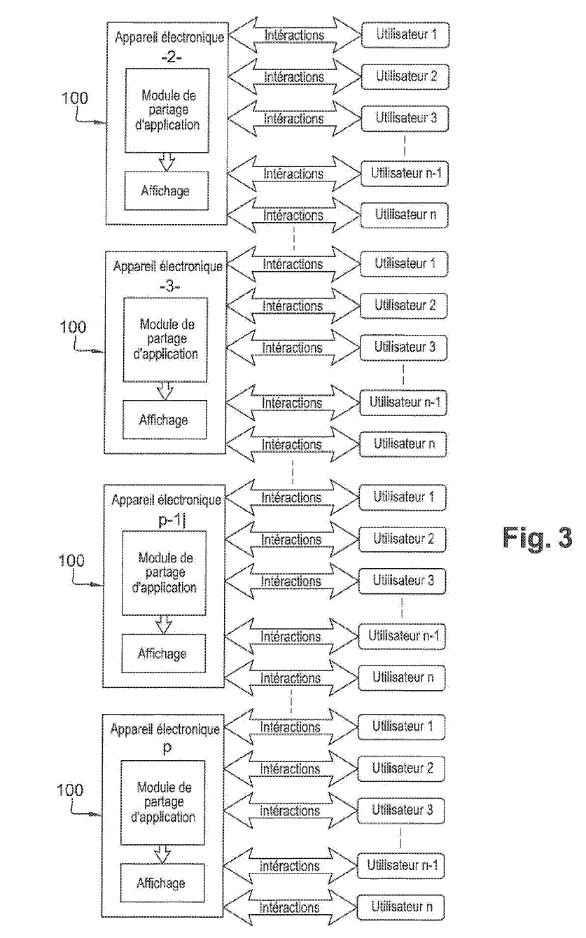

With reference to FIG. 3, at least one or more users interactively share(s) data, files, applications or software, or application and software data on a first electronic device 100, with at least one other user on at least one other electronic device and may simultaneously interact with the various users of the various electronic devices. This solution allows active collaboration of each user on the various electronic devices simultaneously with a display feedback in almost real time on the various devices that allow the display. This solution is particularly useful when there are at least two users who want to share, collaborate and interact on at least two remote electronic devices, so that they may collaborate, share interactive data, files, applications or software, or application and software data, without having to be physically present in the same geographical location.

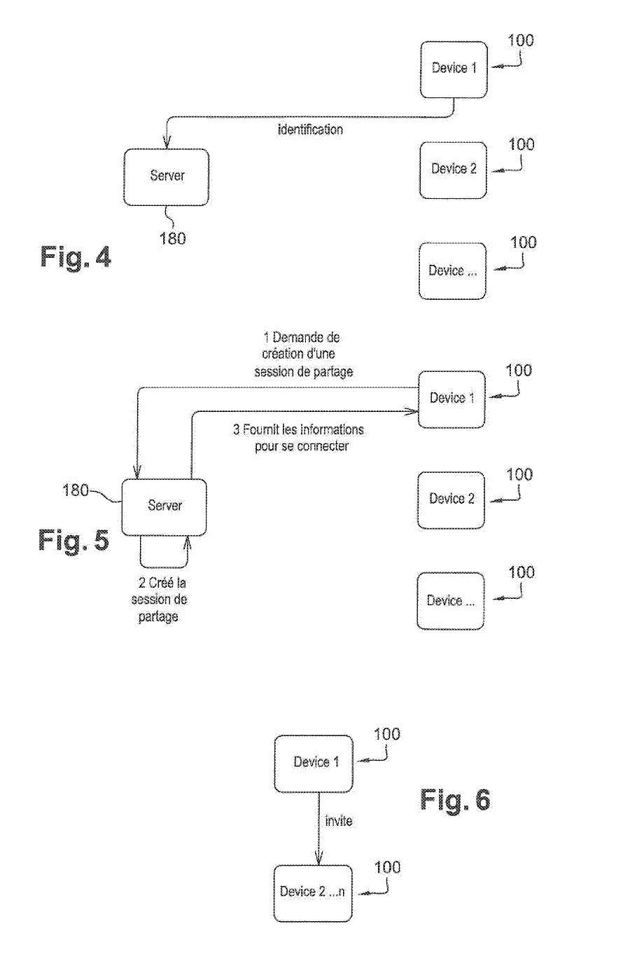

With reference to FIGS. 4 to 10, in a first step (FIG. 4), the sharing module 170 allows connection of a first electronic device 100 to a server 180 via, for example, an internet connection, and identification of the first electronic device 100 by the server 180 as a client. With reference to FIG. 5, the first electronic device 100 then transmits to the server 180 a request to create a sharing session, while the server 180 creates a sharing session and transmits the information relating to this sharing session to the first device 100. Referring to FIG. 6, the first electronic device 100 sends an invitation to other electronic devices 100 to connect to the sharing session. This invitation may be made in different ways. According to a first embodiment, a user sends an invitation email from the first electronic device 100 to users of other electronic devices. In a second embodiment, an invitation email to connect to the sharing session may be generated automatically by the server 180 and sent by the server 180 to users of other electronic devices. Alternatively, the invitation to connect to the sharing session may be performed by telephone, by a notification called In-App, etc. . . . without departing from the scope of the invention. It should be noted that each new electronic device that has received the invitation to connect to the sharing session may also send an invitation to other devices to connect to the session, for example via the email address book.

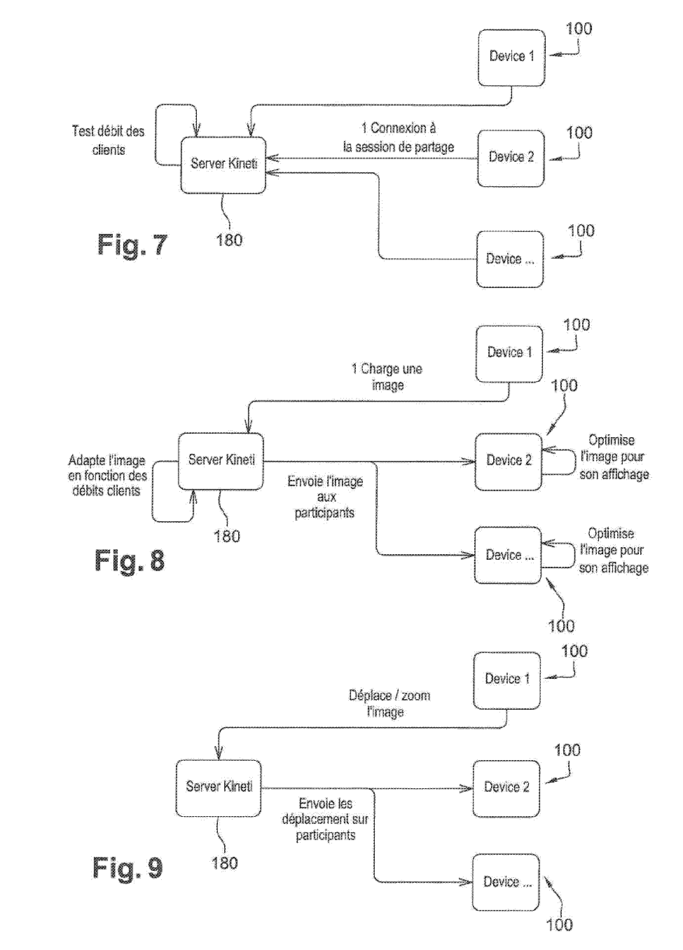

Referring to FIG. 7, the other electronic devices 100 accept the invitation from the server 180 which then tests the bit rate of the connection of each electronic device 100 with the server 180. Whenever an electronic device connects to the server, the bit rate of the connection is checked to choose the information transmission mode and the quality of information sent. In this way, one maximizes the chances of having non-jerky and pleasant exchanges. In addition, the connection speed is checked later at regular intervals to adapt the transmission mode and the send quality according to the bandwidth of the connection.

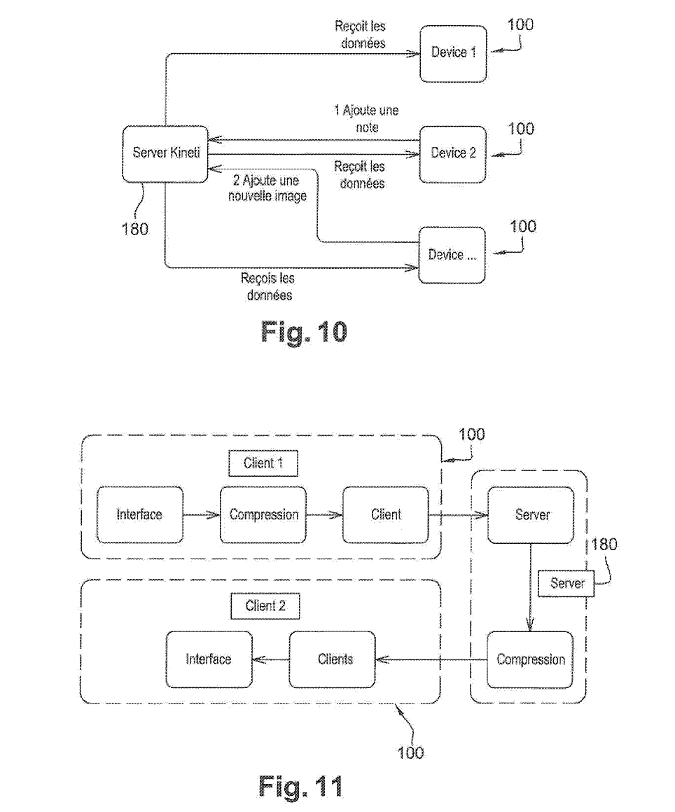

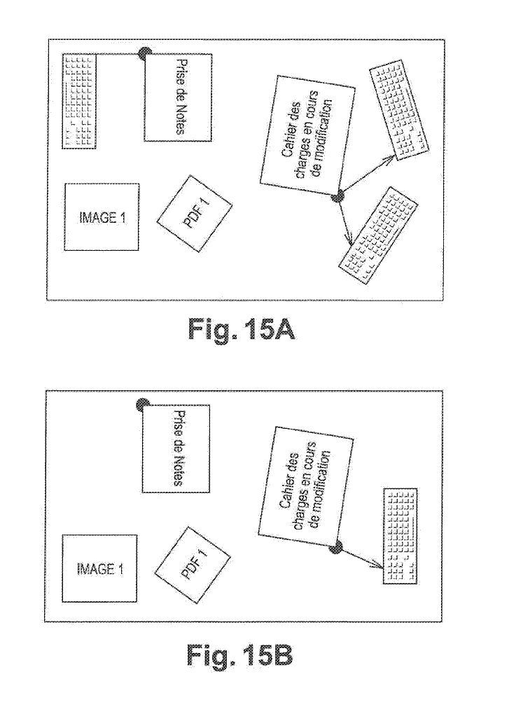

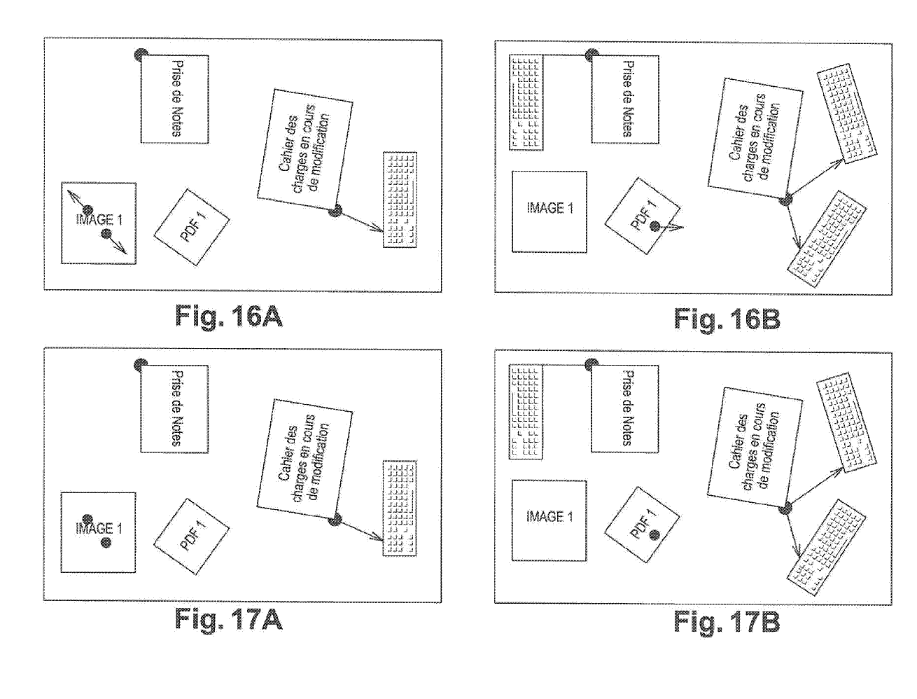

Referring to FIG. 8, when the first electronic device 100 loads data, such as for example an image, the image is transmitted in real time to the other electronic devices 100. It will be noted that, depending on the bit rate of the connection between the electronic devices 100 and the server 180, the image transmitted by the server 180 to the other electronic devices may be compressed (as will be detailed later). The image is downloaded once by the users, modifying, if necessary, the size of the image if the connection of the different users is not sufficiently powerful or if the image is too large. The image is optionally compressed to minimize the bit rate used. Thus, the rendering on the display screens of the electronic devices is the same without any loss of quality of the image, while only the image is transmitted and not the entire screen, unlike prior art methods. Referring to FIG. 9, when the user of the first electronic device effects an action on the image from their electronic device, such as a displacement of the image or a zoom for example, the data relating to the displacement and/or zoom are transmitted to the server 180 which retransmits this data to the other electronic devices 100, so that the displacement and/or the zoom of the image is displayed on the screens of the other electronic devices 100. In this way, the whole image is not reloaded, only the change of position and the change of zoom factor is transmitted to the server 180 and then to the various electronic devices. Thus, this saves a lot of bandwidth compared to streaming of the prior art. Subsequently, with reference to FIG. 10, when an electronic device 100 adds a note and when another electronic device 100 adds a new image, the data is transmitted respectively to the server 180 which then transmits them in real time to all the other electronic devices for displaying the data on the electronic devices as shown in FIG. 15A-17B. In this example, two users interact simultaneously, wherein a first user creates a note, and a second user adds an image. In the case of the note of the first user, only the position of the object and the text (font) are transferred, which reduces the amount of the bandwidth used. In the case of adding a video, the video is streamed in real time but only the frame of the video is streamed and not the display screen comprising the video frame.

With reference to FIG. 11, the sharing module 170 comprises a compression module that makes it possible to choose how the data will be transmitted. Depending on the client bit rate and/or the type of meeting and/or the size of the object, a choice of data transfer is determined: either a transfer of the raw data (without compression) or a resizing of the data. Thus, in the event that the connection between the first electronic device 100 corresponding to the client 1 and the server 180, is of poor quality, the data is compressed before being transmitted to the server 180 and the electronic device 100 corresponding to the client 2. Assuming that the connection between the first electronic device 100 corresponding to the client 1 and the server 180 is of good quality but where the connection between the server 180 and the second electronic device 100 corresponding to the client 2 is of poor quality, the data transmitted by the client 1 are sent to the server 180 without compression, while the server 180 then compresses the data to transmit them to the electronic device 100 corresponding to the client 2.

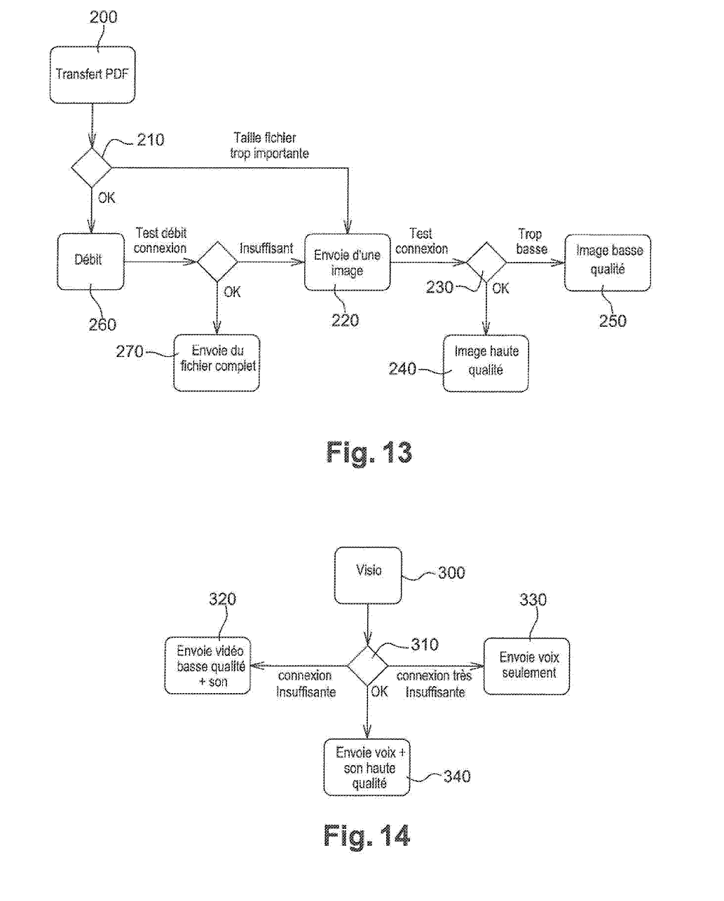

Thus, with reference to FIG. 13, during a transfer of a pdf type file (step 200) from a first electronic device 100 to the server 180, the sharing module determines in a step 210 whether the size of the pdf file is too large or not. If the size of the pdf file is too large, the sharing module determines in a step 220 that an image file must be sent to the other electronic client devices 100. In a step 230, the server sharing module 180 checks the connection between the server 180 and the client electronic devices and, if the connection has a sufficient bit rate, a high quality image is transmitted to the client electronic device in a step 240, while, if the connection has an insufficient bit rate, a low quality image is transmitted to the electronic client device in a step 250. Assuming that the size of the pdf file is too large, the sharing module checks the bit rate of the connection between the server 180 and the client electronic devices in a step 260 and, if the connection has a sufficient bit rate, the sharing module determines that the complete file in pdf format is transmitted to the client electronic device in a step 270, while, if the connection has insufficient bit rate, the sharing module determines in step 220 that an image file must be sent to the other client electronic devices 100.

In the case of a video conference, with reference to FIG. 14, when a video conference request is transmitted to the server 180 in a step 300, the server sharing module 180 tests the bit rate of the server connections with the other electronic devices 100 in a step 310. If the bit rate of the connection is insufficient, the server 180 sends a low quality video with sound (320) to the corresponding electronic device. If the connection rate is very insufficient, the server 180 only sends sound (330) to the corresponding electronic device, while, if the connection rate is sufficient, the server 180 sends a high quality video with sound (340) to the corresponding electronic device.

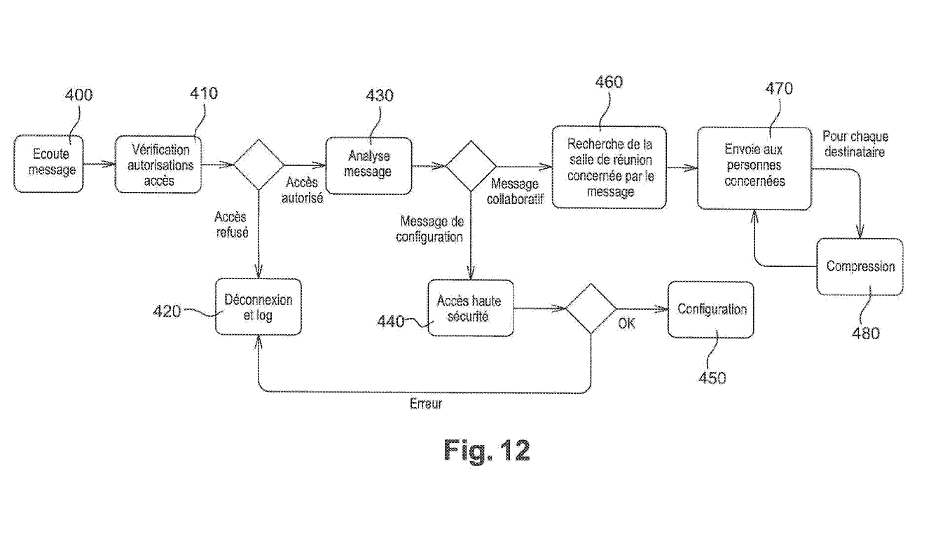

Moreover, the sharing module 170 comprises, with reference to FIG. 12, a so-called server module which is hosted on a public server directly accessible by any device connected to the Internet. The server may consist of a remote server or an embedded server on one of the electronic devices 100. The server module manages the connection of the users, the persons authorized to access them and the meeting rooms by means of an identifier. The module will then receive messages from clients and redistribute them to the right people. This redistribution is effected in an intelligent way, and the transmitted commands will be different according to the bandwidth available to the users. Thus, with reference to FIG. 12, the server module receives and listens for a message transmitted by an electronic device in a step 400, then verifies the access authorization contained in the message in a step 410. If the access is refused, the server module disconnects the electronic device in a step 420. If access is allowed, the server module parses the message in a step 430 to determine whether it is a configuration message or a collaborative message. If it is a configuration message, the server module verifies that the high security access is authorized in a step 440 and proceeds to the configuration in a step 450 if the access is authorized, or disconnects (420) if access is not allowed. If it is a collaborative message, the server module searches for the meeting room corresponding to the message in a step 460 and sends the message to the different users connected to the meeting room in question in a step 470. The content of the message may be compressed in a step 480 before sending it to the various users depending on the quality of the each user's connection with the server 180.

Furthermore, the method according to the invention comprises a step of generating at least one command from an interaction between at least one user and the electronic device. The interaction may be performed by any means well known to persons skilled in the art such as pressure on a touch screen, movement in front of a Kinect system (registered trademark) or the like, movement of a mouse, input on a keyboard, etc. . . .

For example, pressing and/or moving a finger on the touch screen of the device generates a request that is transmitted to the other electronic devices for displaying a pointer, while pressing and/or moving with two fingers on the touch screen of the device generates a request that is transmitted to other devices for moving and/or zooming and/or changing the application and/or data positioned under the fingers.

In addition, it comprises a step of generating at least one command from an object interacting with the electronic device. For example, a pencil interacting with a touch screen of an electronic device generates an annotation in a window generated by the display module of the electronic device.

Advantageously, the history of each sharing session is recorded on a medium. By “history of each sharing session” is meant the history of the commands and/or elements displayed on the various electronic devices and/or connections/disconnections of the electronic devices to the sharing session, etc.

The method according to the invention comprises a step of loading the last state of a given sharing session. The term “state” means all the applications and/or data and/or control interfaces previously saved. In this case, all the electronic devices of the sharing session are automatically connected to the sharing session and all the applications and/or data and/or control interfaces are automatically shared on the electronic devices, wherein the applications and/or data and/or control interfaces that are displayed on the screens of the various electronic devices connected to the sharing session are those displayed during the last closing of the sharing session, wherein the latter are saved during the closing of the sharing session. In this way, it is possible to resume a work session, for example, after a break of several hours and/or several days.

Furthermore, advantageously, the display, i.e. the dimensions and/or the orientation and/or the positioning on the screen of the one or more electronic devices connected to the sharing session(s), the application(s) and/or the data and/or peripheral(s) shared by at least one of the electronic devices, is adapted according to the dimensions of the screen of the one or more electronic devices and/or technical characteristics of the electronic device(s).

In addition, depending on the dimensions of the screen and/or the technical characteristics of the electronic device(s), the display on the screen of the electronic device(s) corresponds to an enlargement or a reduction of at least one determined zone of the display of another electronic device connected to the sharing session.

Finally, it is quite obvious that tablets or touch-screen tables may be any electronic device well known to persons skilled in the art and that the examples that have been given above are only particular illustrations and in no way limiting as to the fields of application of the invention.

1. A method for interactively sharing at least one program and/or at least one data item and/or at least one peripheral between at least two electronic devices, the method comprising at least the following steps:
initiation of at least one sharing session by at least a first electronic device;
connection of at least one second electronic device to the open sharing session(s);
execution of at least one application and/or at least one data item and/or at least one control interface of at least one shared peripheral in the open sharing session(s);
accessibility of the control of at least one application and/or at least one data item and/or at least one control interface of at least one shared peripheral in the one or more sharing session(s) opened by each of the electronic devices connected to the sharing session;
execution of a display module of at least one application and/or at least one data item and/or at least one control interface of at least one shared peripheral on the device(s) connected to the sharing session(s); and
display on the screen of the electronic device(s) connected to the sharing session(s) of the application(s) and/or the data and/or the control interface of at least one shared peripheral by at least one of the electronic devices.

2. The method according to claim 1 wherein the initiation of the sharing session comprises at least the following steps:
connection of a first electronic device to a server; and
opening a sharing session from the electronic device.

3. The method according to claim 1 wherein the initiation of the sharing session comprises at least the following steps:
opening a sharing session from a first electronic device; and
connecting the first electronic device to a server.

4. The method according to claim 1 further comprising the following steps:
connection of a first electronic device to a server via an internet connection;
identification of the first electronic device by the server as a client;
connection of at least one second electronic device to the server;
identification in the sharing session of the one or more electronic devices by the server as a client;
transmission from one of the electronic devices connected to the sharing session of at least one command or at least one data item to at least one application and/or at least one data item and/or at least one control interface executed in the sharing session;
execution of the command and/or the data by the application and/or data and/or control interface executed in the sharing session; and
transmission of the result of the execution of the command and/or the data by the application and/or data and/or control interface executed in the sharing session to the display module.

5. The method according to claim 4 further comprising the following steps:
generation by the server of at least one command to change the displayed screen of the one or more client electronic device(s) according to the variation of the data; and
transmission of the command(s) to the client electronic device(s) to change the displayed screen.

6. The method according to claim 4 further comprising the following steps:
determination of the variation of the data relating to the displayed screen of a first electronic device between the instant t and the instant t−1; and
transmission of the variation of the data relating to the displayed screen of the first electronic device to the server.

7. The method according to claim 4 wherein the server is located on at least one of the electronic devices.

8. The method according to claim 4 wherein the server consists of a remote server connected to a communication network.

9. The method according to claim 4 wherein the server generates one or more commands for the one or more client electronic device(s) as a function of the bandwidth of the connection between the client electronic device(s) and the server.

10. The method according to claim 1, wherein the program and/or the shared data are compressed when the bandwidth of the connection between the first electronic device and the second electronic device(s), is less than or equal to a predetermined value.

11. The method according to claim 1 further comprising, upon each connection of an electronic device to the sharing session, a step of determining a privacy indicator to determine whether the application(s) and/or the data and/or device(s) may be fully or partially shared or not.

12. The method according to claim 1, further comprising, upon each connection of an electronic device to the sharing session, a step of determining a sharing indicator to determine whether the other device(s) connected to the sharing session is/are allowed or is/are blocked from accessing applications and/or data and/or device control interfaces of the electronic device.

13. The method according to claim 1 wherein the applications and/or shared data are stored on a remote server or cloud.

14. The method according to claim 1 in which a plurality of users may manipulate the application(s) and/or the data and/or the peripheral(s) on the same electronic device.

15. The method according to claim 1 wherein at least one electronic device comprises at least one touch screen.

16. The method according to claim 1 further comprising a step of generating at least one command from an interaction between at least one user and the electronic device.

17. The method according to claim 16 wherein a pressure and/or a movement with a finger on the touch screen of the device generates a request transmitted to the other electronic devices for displaying a pointer.

18. The method according to claim 16, wherein a pressure and/or displacement with two fingers on the touch screen of the device generates a request transmitted to the other devices for moving and/or zooming and/or changing the application and/or data positioned under the fingers.

19. The method according to claim 1 further comprising a step of generating at least one command from an object interacting with the electronic device.

20. The method according to claim 19 wherein a pencil interacting with a touch screen of an electronic device generates an annotation in a window generated by the display module of the electronic device.

21. The method according to claim 1 wherein the history of each sharing session is recorded on a medium.

22. The method according to claim 1 wherein the display, i.e. dimensions and/or orientation and/or positioning, on the screen of the one or more electronic devices connected to the sharing session(s) of the application(s) and/or the data and/or peripheral(s) shared by at least one of the electronic devices is adapted according to the dimensions of the screen of the one or more electronic devices and/or the technical characteristics of the electronic device(s).

23. The method according to claim 1 wherein, depending on the screen dimensions and/or the technical characteristics of the electronic device(s), the display on the screen of the electronic devices corresponds to enlarging or reducing at least one determined zone of the display of another electronic device connected to the sharing session.

24. The method according to claim 1 wherein the applications and/or data and/or control interfaces are saved upon closing the sharing session and, upon reopening the sharing session by one of the electronic devices, all the electronic devices of the sharing session are automatically connected to the sharing session, while all the applications and/or data and/or control interfaces are automatically shared on the electronic device.

25. A computer program product for interactively sharing at least one program and/or at least one data item and/or at least one device between at least two electronic devices, wherein the computer program product comprises a sequence of instructions for the implementation of a method according to claim 1.
